(19) United States
(12) Patent Application Publication
(10) Pub. No.: US 2025/0170878 A1
(43) Pub. Date: May 29, 2025

(54) CAR MOUNTED HUMIDIFIER

(71) Applicant: GUANGZHOU ISSYZONE TECHNOLOGY CO., LIMITED, Guangzhou (CN)

(72) Inventors: TAIPING YANG, Shenzhen (CN); SHIPEI LI, Shaoguan (CN); JIANJIE CHEN, Guangzhou (CN); SHUJIAN CHEN, Guangzhou (CN)

(21) Appl. No.: 18/796,041

(22) Filed: Aug. 6, 2024

(30) Foreign Application Priority Data
Nov. 28, 2023 (CN) 202323219465.X

(51) Int. Cl. B60H 3/02; F24F 6/12; F24F 6/14

(52) U.S. Cl. CPC B60H 3/022; F24F 6/12; B60H 2003/026; F24F 2006/146

(57) ABSTRACT

A car mounted humidifier is provided, which includes a humidifier unit, a water cup groove, and a fixing member that are arranged coaxially from top to bottom. A lower edge of the humidifier unit is hinged with an opening edge of the water cup groove through a hinge member. The beneficial effect of the present disclosure is that providing with the fixing member at a bottom of the water cup groove, the fixing member is inserted into an original water cup holder before use, which plays a fixed role as a whole. The water cup groove replaces the original water cup holder in its original position, and the lower edge of the humidifier unit is hinged with the opening edge of the water cup groove through the hinge member.

### CROSS-REFERENCE TO RELATED APPLICATIONS

This application claims priority to Chinese Patent Application No. 202323219465.X, filed on Nov. 28, 2023, which is hereby incorporated by reference in its entirety.

### TECHNICAL FIELD

The present disclosure relates to the field of humidifier technologies, and in particular, to a car mounted humidifier.

### BACKGROUND

Most existing car mounted humidifiers have cylindrical shells. When in use, the car mounted humidifier is directly placed into an original water cup holder in the car. An inner wall of the original water cup holder is used to radially limit the car mounted humidifier, keeping it upright during operation, and ensuring an end of a suction pipe in the car mounted humidifier can smoothly contact liquid. However, the number of original water cup holders in the car is limited. When the placement of the car mounted humidifier occupies the space of the original water cup holder in the car, one of the driver and passenger can only give up drinking beverages while driving, or purchase a new water cup holder to be installed in other positions in the car. Regardless which situation, it cannot solve the problem of car mounted humidifier occupying a water cup holder position, especially the latter. For the driver, providing with the original water cup holder on a center console is already the most reasonable design. Due to a stable support provided by a lower position of the center console, beverages placed in the original water cup holder is relatively less likely to spill. However, in the current market, the car mounted cup holder launched by the company generally needs to be clamped at an air conditioning outlet through a fixture, which poses a high risk of spillage for beverages.

### SUMMARY

In response to the above problems, the present disclosure provides a car mounted humidifier, mainly solving the problem that the car mounted humidifier needs to occupy a position of an original car water cup holder.

To solve the above technical problems, the technical solution of the present disclosure is as follows.

A car mounted humidifier, including a humidifier unit, a water cup groove, and a fixing member that are arranged coaxially from top to bottom, where a lower edge of the humidifier unit is hinged with an opening edge of the water cup groove through a hinge member.

In some embodiments, a rotational axis of the hinge member is parallel to an axis of the water cup groove.

In some embodiments, the fixing member includes a fixed shaft fixed at a center of a lower end face of the water cup groove, and an elastic member provided on a peripheral side of the fixed shaft.

In some embodiments, the elastic member is a plurality of soft rubber flaps uniformly arranged along an axis direction of the fixed shaft.

In some embodiments, the humidifier unit includes an upper shell and a lower shell that are detachably buckled; an interior of the upper shell is provided with a pumping unit, and an end of the pumping unit is extended into an internal of the lower shell.

In some embodiments, an inner bottom of the lower shell is provided with a partition, which divides an internal of the lower shell into a first water storage tank and a second water storage tank; the pumping unit includes a first suction pipe and a second suction pipe, the first suction pipe and the second suction pipe are respectively inserted into the first water storage tank and the second water storage tank.

In some embodiments, ends of the first suction pipe and second suction pipe respectively abut against bottoms of the first water storage tank and the second water storage tank.

In some embodiments, the partition is configured to be a circular baffle, and a height of an opening end of the circular baffle is consistent with a height of an opening end of the lower shell.

In some embodiments, an upper end surface of the upper shell is respectively provided with a first spray hole and a second spray hole communicated with the first suction pipe and the second suction pipe.

In some embodiments, a control unit and a lighting unit are provided in the upper shell, an induction unit is provided on an upper end face of the upper shell, and a loophole is provided on a periphery of the upper shell to allow light waves to pass through; where the control unit is configured to obtain an obstacle signal feedback from the induction unit and trigger the lighting unit to start based on the obstacle signal.

The beneficial effect of the present disclosure is as follows: by providing with a fixing member at a bottom of the water cup groove, the fixing member is inserted into an original water cup holder before use, which plays a fixed role as a whole. The water cup groove replaces the original water cup holder in situ, and the lower edge of the humidifier unit is hinged with the opening edge of the water cup groove through the hinge member. Therefore, while retaining the function of the original water cup holder, a user can rotate the humidifier unit with the hinge member as a rotation axis according to his own needs, the humidifier unit is placed directly on the water cup groove, or the humidifier unit is pushed away from the top of the water cup groove, thereby achieving the function of the car mounted humidifier not occupying the original car mounted water cup holder.

### BRIEF DESCRIPTION OF DRAWINGS

FIG. 1 is a first schematic structural diagram of a car mounted humidifier disclosed in an embodiment of the present disclosure.

FIG. 2 is a second schematic structural diagram of the car mounted humidifier disclosed in an embodiment of the present disclosure.

FIG. 3 is an explosion schematic diagram of the car mounted humidifier disclosed in an embodiment of the present disclosure.

Numeral reference: 1—humidifier unit, 2—water cup groove, 3—fixing member, 4—hinge member, 101—upper shell, 102—lower shell, 103—baffle, 104—first water storage tank, 105—second water storage tank, 106—first suction pipe, 107—second suction pipe, 108—first spray hole, 109—second spray hole, 110—induction unit, 111—loophole, 301—fixed shaft, 302—elastic member.

### DESCRIPTION OF EMBODIMENTS

In order to make the purpose, technical solution, and advantages of the present disclosure clearer and definite, the following will provide further detailed explanations of the present disclosure in combination with the accompanying drawings and specific embodiments. It can be understood that the specific embodiments described here are only intended to explain the present disclosure and not to limit it. Furthermore, it should be noted that for ease of description, only relevant parts of the present disclosure are shown in the accompanying drawings, rather than the entire content.

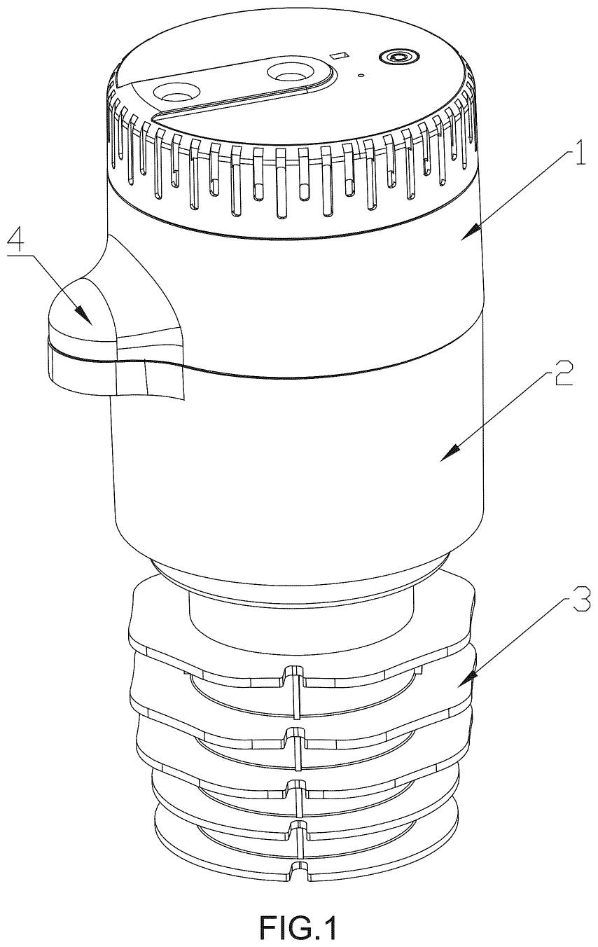

This embodiment provides a car mounted humidifier, as shown in FIG. 1, including a humidifier unit 1, a water cup groove 2, and a fixing member 3 that are arranged coaxially from top to bottom. A lower edge of the humidifier unit 1 is hinged with an opening edge of the water cup groove 2 through a hinge member 4. In the absence of the need to use the water cup groove 2, the humidifier unit 1 can be covered at an upper end of the water cup groove 2 through the hinge member 4, which can hide the water cup groove 2 and save an interior space. In the case of using the water cup groove 2, the humidifier unit 1 rotates with the hinge member 4 as a rotation axis, then the water cup groove 2 is exposed.

In this embodiment, by providing with the fixing member 3 at a bottom of the water cup groove 2, the fixing member 3 is inserted into an original water cup holder before use, which plays a fixed role as a whole. The water cup groove 2 replaces the original water cup holder in situ. In an implementation, the lower edge of the humidifier unit 1 is hinged with the opening edge of the water cup holder 2 through the hinge member 4. Therefore, while retaining the function of the original water cup holder, a user can rotate the humidifier unit 1 with the hinge member 4 as the rotation axis according to his own needs, the humidifier unit 1 is placed directly on the water cup groove 2, or the humidifier unit 1 is pushed away from the top of the water cup groove 2, thereby achieving a function that the car mounted humidification does not occupy the original car mounted water cup holder.

In this scheme, the humidifier unit 1 and the water cup groove 2 should be two components with a same vertical projection area so that the humidifier unit 1 completely covers the opening of the water cup groove 2. In addition, the humidifier unit 1 in this embodiment can be any device capable of achieving liquid atomization, which can be either ultrasonic humidification or electric humidification, as it can achieve an expected function.

The hinge member 4 can be a common hinge structure. In addition, there are no special requirements for a rotation direction of the humidifier unit 1. On the premise that the beverage bottle can be placed normally in the water cup groove 2, normal suction and atomization of the humidifier unit 1 can be achieved. Considering that not all humidifiers can achieve lateral suction, in an implementation scheme, the rotation axis of the hinge member 4 is parallel to an axis of the water cup groove 2, that is, the rotation axis of the hinge member 4 is vertical to the ground. In this scheme, under a condition that the fixing member 3 is already inserted into the original water cup holder, the humidifier unit 1 can rotate 360 degrees along the hinge member 4 until the water cup groove 2 is exposed to the user's view. Based on this, an end face of the humidifier unit 1 is always parallel to the ground, and to-be-atomized liquid always accumulates at a bottom of the humidifier unit 1, so an atomization process is not affected.

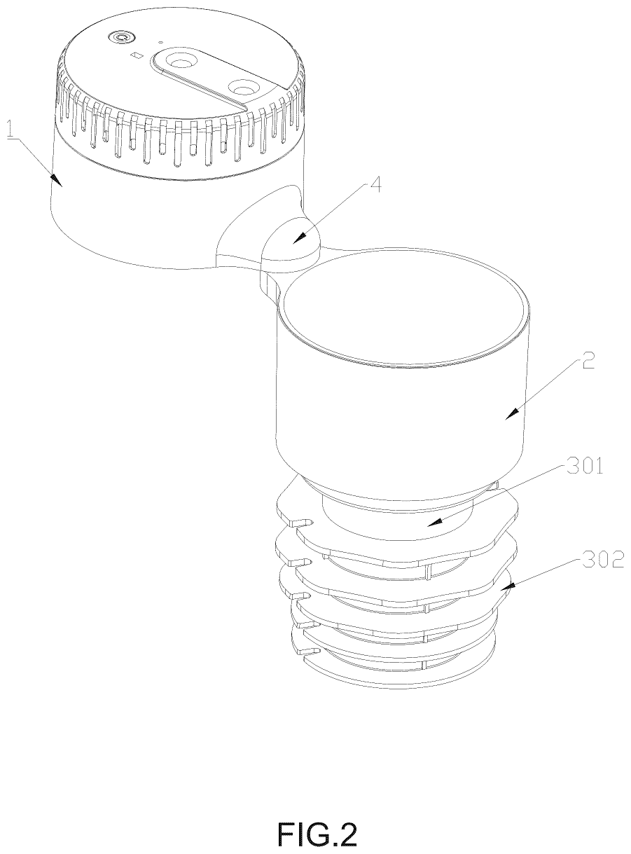

In this embodiment, the fixation of the water cup groove 2 mainly utilizes a fitting relationship between the fixing member 3 and the original water cup holder, which can be an interference fit or various snap structures. Taking the former as an example, as shown in FIG. 2, the fixing member 3 includes a fixed shaft 301 fixed at a center of a lower end face of the water cup groove 2, and an elastic member 302 provided on a peripheral side of the fixed shaft 301. This scheme provides a fixed position for the elastic member 302 by providing with the fixed shaft 301. When the elastic member 302 is inserted into the original water cup holder, an inner wall of the original water cup holder provides radial support for the elastic member 302, and a compression of the elastic member 302 generates an elastic force, a strong frictional force is formed between the inner wall of the original cup holder with the elastic member 302, thereby the water cup groove 2 being firmly installed on the original water cup holder.

In an implementation, the elastic member 302 is a plurality of soft rubber flaps uniformly arranged along an axis direction of the fixed shaft 301. Of course, other elastic structures can also be selected to achieve the technical effect.

In an example, the humidifier unit 1 includes an upper shell 101 and a lower shell 102 that can be detachably buckled, for example, it can be bucked and sealed by a rotating buckle structure to prevent liquid leakage. A pumping unit is provided in the upper shell 101, and an end of the pumping unit is extended into an internal space of the lower shell 102.

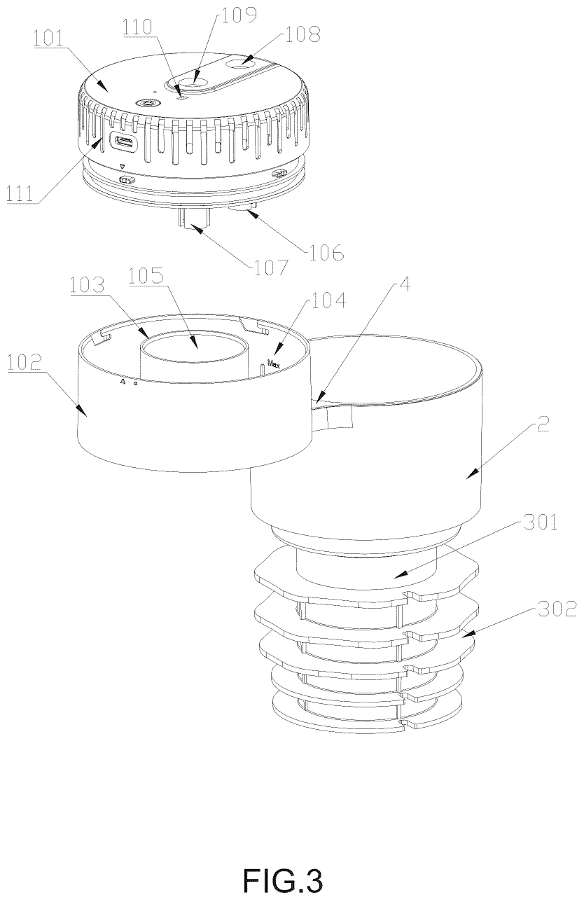

In order to enhance a spray function of the humidifier unit 1 and enable it to spray two kinds of atomized droplets, this embodiment has improved its structure. In an implementation, as shown in FIG. 3, an inner bottom of the lower shell 102 is provided with a partition 103, which divides an internal space of the lower shell 102 into a first water storage tank 104 and a second water storage tank 105. The pumping unit includes a first suction pipe 106 and a second suction pipe 107, and the first suction pipe 106 and the second suction pipe 107 are inserted into the first water storage tank 104 and the second water storage tank 105, respectively. In an implementation, ends of the first suction pipe 106 and the second suction pipe 107 respectively abut against bottoms of the first water storage tank 104 and the second water storage tank 105, allowing the suction pipe to fully absorb the to-be-atomized liquid.

In an implementation, the partition 103 is configured to be a circular baffle, and a height of an opening end of the circular baffle is consistent with a height of an opening end of the lower shell 102. In this scheme, the circular baffle divides the internal space of the lower shell 102 into an outer circular water storage tank and an inner cylindrical water storage tank, compared with a flat baffle for left and right partitioning.

Correspondingly, an upper end surface of the upper shell 101 is respectively provided with a first spray hole 108 and a second spray hole 109 which are communicated with the first suction pipe 106 and the second suction pipe 107. The liquid extracted from the suction pipe is directly sprayed out of the spray hole after atomization.

To improve an intelligent control level of this device, a control unit (not shown in the drawing) and a lighting unit (not shown in the drawing) are provided in the upper shell 101. An upper end face of the upper shell 101 is provided with an induction unit 110, which can be either a light induction switch or an infrared induction switch. A peripheral side of the upper shell 101 is provided with a loophole 111 for allowing light waves to pass through. In an implementation, there are a plurality of loopholes 111, which should be uniformly arranged in a circular manner along the peripheral side of the upper shell 101. The control unit is configured to obtain obstacle signal feedback from the induction unit 110 and trigger the lighting unit to start based on the obstacle signal. In this scheme, when the user's hand approaches the induction unit 110, the induction unit 110 generates the obstacle signal, and the control unit detects a state of the induction unit 110, which then triggers the lighting unit to start, and display it through the loophole 111.

The above embodiments are only intended to illustrate the technical concept and characteristics of the present disclosure. The purpose is to enable ordinary technical personnel in the field to understand the content of the present disclosure and implement it accordingly, and cannot limit the protection scope of the present disclosure. Any equivalent changes or modifications made based on the essence of the content of the present disclosure should be covered within the protection scope of the present disclosure.

What is claimed is:

1. A car mounted humidifier, comprising: a humidifier unit, a water cup groove, and a fixing member that are arranged coaxially from top to bottom, wherein a lower edge of the humidifier unit is hinged with an opening edge of the water cup groove through a hinge member.

2. The car mounted humidifier as claimed in claim 1, wherein a rotational axis of the hinge member is parallel to an axis of the water cup groove.

3. The car mounted humidifier as claimed in claim 1, wherein the fixing member comprises a fixed shaft fixed at a center of a lower end face of the water cup groove, and an elastic member provided on a peripheral side of the fixed shaft.

4. The car mounted humidifier as claimed in claim 3, wherein the elastic member is a plurality of soft rubber flaps uniformly arranged along an axis direction of the fixed shaft.

5. The car mounted humidifier as claimed in claim 1, wherein the humidifier unit comprises an upper shell and a lower shell that are detachably buckled; an interior of the upper shell is provided with a pumping unit, and an end of the pumping unit is extended into an internal of the lower shell.

6. The car mounted humidifier as claimed in claim 5, wherein an inner bottom of the lower shell is provided with a partition, which divides an internal of the lower shell into a first water storage tank and a second water storage tank; the pumping unit comprises a first suction pipe and a second suction pipe, the first suction pipe and the second suction pipe are respectively inserted into the first water storage tank and the second water storage tank.

7. The car mounted humidifier as claimed in claim 6, wherein ends of the first suction pipe and second suction pipe respectively abut against bottoms of the first water storage tank and the second water storage tank.

8. The car mounted humidifier as claimed in claim 6, wherein the partition is configured to be a circular baffle, and a height of an opening end of the circular baffle is consistent with a height of an opening end of the lower shell.

9. The car mounted humidifier as claimed in claim 5, wherein an upper end surface of the upper shell is respectively provided with a first spray hole and a second spray hole communicated with the first suction pipe and the second suction pipe.

10. The car mounted humidifier as claimed in claim 5, wherein a control unit and a lighting unit are provided in the upper shell, an induction unit is provided on an upper end face of the upper shell, and a loophole is provided on a periphery of the upper shell to allow light waves to pass through; wherein the control unit is configured to obtain an obstacle signal feedback from the induction unit and trigger the lighting unit to start based on the obstacle signal.
